(19) United States
(12) Patent Application Publication
(10) Pub. No.: US 2005/0056552 A1
(43) Pub. Date: Mar. 17, 2005

(54) Increasing bias for oxygen production in an electrode system

(76) Inventors: Peter C. Simpson, Del Mar, CA (US); Paul Goode, Murrieta, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/896,772

(22) Filed: Jul. 21, 2004

Related U.S. Application Data
(60) Provisional application No. 60/490,010, filed on Jul. 25, 2003.

(51) Int. Cl. G01N 27/26

(52) U.S. Cl. 205/782; 204/406

(57) ABSTRACT

The present invention relates generally to systems and methods for electrochemical sensing. Particularly, the invention relates to optimizing bias settings in an electrode system to increase oxygen production at the working electrode.

### RELATED APPLICATION

This application claims the benefit of U.S. Provisional Application No. 60/490,010 filed Jul. 25, 2003, the contents of which are hereby incorporated by reference in their entirety.

### FIELD OF THE INVENTION

The present invention relates generally to systems and methods for electrochemical sensing. Particularly, the invention relates to optimizing bias settings in an electrode system to increase oxygen production at the working electrode.

### BACKGROUND OF THE INVENTION

Electrochemical sensors are useful in chemistry and medicine to determine the presence and concentration of a biological analyte. Such sensors are useful, for example, to monitor glucose in diabetic patients and lactate during critical care events.

Diabetes mellitus is a disorder in which the pancreas cannot create sufficient insulin (Type I or insulin dependent) and/or in which insulin is not effective (Type 2 or non-insulin dependent). In the diabetic state, the victim suffers from high blood sugar, which causes an array of physiological derangements (kidney failure, skin ulcers, or bleeding into the vitreous of the eye) associated with the deterioration of small blood vessels. A hypoglycemic reaction (low blood sugar) is induced by an inadvertent overdose of insulin, or after a normal dose of insulin or glucose-lowering agent accompanied by extraordinary exercise or insufficient food intake.

Conventionally, a diabetic person carries a self-monitoring blood glucose (SMBG) monitor, which typically utilizes uncomfortable finger pricking methods. Due to the lack of comfort and convenience, a diabetic normally only measures his or her glucose level two to four times per day. Unfortunately, these time intervals are so far spread apart that the diabetic likely finds out too late, sometimes incurring dangerous side effects, of a hyperglycemic or hypoglycemic condition. In fact, it is not only unlikely that a diabetic takes a timely SMBG value, but additionally the diabetic will not know if their blood glucose value is going up (higher) or down (lower) based on conventional methods.

Consequently, a variety of transdermal and implantable electrochemical sensors are being developed for continuous detecting and/or quantifying of blood glucose values. Many implantable glucose sensors suffer from complications within the body and provide only short-term or less-than-accurate sensing of blood glucose. Similarly, transdermal sensors have problems accurately sensing and reporting back glucose values continuously over extended periods of time. Some efforts have been made to obtain blood glucose data from implantable devices and to retrospectively determine blood glucose trends for analysis; however these efforts do not aid the diabetic in determining real-time blood glucose information. Some efforts have also been made to obtain blood glucose data from transdermal devices for prospective data analysis. However, similar problems have occurred.

### SUMMARY OF THE PREFERRED EMBODIMENTS

Accordingly, electrochemical sensors that offer improved device performance by modifying the bias potential to produce oxygen are desirable.

In a first embodiment, an electrochemical sensor for determining a presence or a concentration of an analyte in a fluid is provided, the sensor including a working electrode including a conductive material; and a reference electrode including a conductive material, wherein the sensor is configured such that a bias potential can be applied between the working electrode and the reference electrode at a level such that the working electrode measures the concentration of the analyte and produces oxygen in a reaction with water or another electroactive species in the fluid.

In an aspect of the first embodiment, the bias potential is from about 0.05 V to about 0.4 V above a level at which the working electrode measures a signal only from the analyte.

In an aspect of the first embodiment, the bias potential is above about +0.6V.

In an aspect of the first embodiment, the bias potential is above about +0.7V.

In an aspect of the first embodiment, the bias potential is above about +0.8V.

In an aspect of the first embodiment, the bias potential is above about +0.9V.

In an aspect of the first embodiment, the sensor is configured to continuously adjust the bias potential so as to continuously produce oxygen in a reaction with water or another electroactive species in the fluid.

In an aspect of the first embodiment, the sensor is configured to apply the bias at a plurality of different bias settings.

In an aspect of the first embodiment, the sensor is configured to switch the bias potential between a plurality of different bias settings at increments, for example, wherein the increments include regular intervals or wherein the increments include a system break-in period.

In an aspect of the first embodiment, the sensor is configured to switch the bias potential between a plurality of different bias settings based on a condition, for example, a condition including at least one of oxygen concentration, signal noise, signal sensitivity, and baseline shifts.

In a second embodiment, a method for generating oxygen by an electrochemical analyte sensor is provided, the method including providing an electrochemical cell including a working electrode and a reference electrode; applying a bias potential between the working electrode and the reference electrode, whereby the working electrode measures the concentration of an analyte and produces oxygen in a reaction with water or another electroactive species in the fluid.

In an aspect of the second embodiment, the bias potential is from about 0.05 V to about 0.4 V above a level at which the working electrode measures a signal only from the analyte.

In an aspect of the second embodiment, the bias potential is above about +0.6V.

In an aspect of the second embodiment, the bias potential is above about +0.7V.

In an aspect of the second embodiment, the bias potential is above about +0.8V.

In an aspect of the second embodiment, the bias potential is above about +0.9V.

In an aspect of the second embodiment, the bias potential is continuously applied.

In an aspect of the second embodiment, the step of applying the bias potential includes applying a plurality of different bias potentials.

an aspect of the second embodiment, the step of applying the bias potential includes incrementally applying a plurality of different bias potentials.

In an aspect of the second embodiment, the step of applying the bias potential includes applying a plurality of different bias potentials at regular intervals.

In an aspect of the second embodiment, the step of applying the bias potential includes applying a plurality of different bias potentials for a system break-in period.

In an aspect of the second embodiment, the method further includes the step of monitoring the electrochemical sensor for at least one condition; wherein the step of applying the plurality of different bias settings includes selectively switching between the different bias settings based on the at least one condition.

In an aspect of the second embodiment, the step of monitoring the electrochemical sensor includes monitoring at least one of oxygen concentration, signal noise, signal sensitivity, and baseline shifts.

### BRIEF DESCRIPTION OF THE DRAWINGS

FIG. 1 is an exploded perspective view of one exemplary embodiment comprising an implantable glucose sensor that utilizes amperometric electrochemical sensor technology to measure glucose.

FIG. 2 is a block diagram that illustrates the sensor electronics in one embodiment; however a variety of sensor electronics configurations can be implemented with the preferred embodiments.

FIG. 3 is a circuit diagram of a potentiostat configured to control the three-electrode system described with reference to FIGS. 1 and 2.

FIG. 4A is a graph that shows a raw data stream obtained from a glucose sensor over an approximately 4 hour time span in one example.

FIG. 4B is a graph that shows a raw data stream obtained from a glucose sensor over an approximately 36 hour time span in another example.

### DETAILED DESCRIPTION OF THE PREFERRED EMBODIMENT

The following description and examples illustrate some exemplary embodiments of the disclosed invention in detail. Those of skill in the art will recognize that there are numerous variations and modifications of this invention that are encompassed by its scope. Accordingly, the description of a certain exemplary embodiment should not be deemed to limit the scope of the present invention.

Definitions

In order to facilitate an understanding of the preferred embodiments, a number of terms are defined below.

The term “analyte” as used herein is a broad term and is used in its ordinary sense, including, without limitation, to refer to a substance or chemical constituent in a biological fluid (for example, blood, interstitial fluid, cerebral spinal fluid, lymph fluid or urine) that can be analyzed. Analytes can include naturally occurring substances, artificial substances, metabolites, and/or reaction products. In some embodiments, the analyte for measurement by the sensing regions, devices, and methods is glucose. However, other analytes are contemplated as well, including but not limited to acarboxyprothrombin; acylcamitine; adenine phosphoribosyl transferase; adenosine deaminase; albumin; alpha-fetoprotein; amino acid profiles (arginine (Krebs cycle), histidine/urocanic acid, homocysteine, phenylalanine/tyrosine, tryptophan); andrenostenedione; antipyrine; arabinitol enantiomers; arginase; benzoylecgonine (cocaine); biotinidase; biopterin; c-reactive protein; camitine; camosinase; CD4; ceruloplasmin; chenodeoxycholic acid; chloroquine; cholesterol; cholinesterase; conjugated 1-β hydroxy-cholic acid; cortisol; creatine kinase; creatine kinase MM isoenzyme; cyclosporin A; d-penicillamine; de-ethylchloroquine; dehydroepiandrosterone sulfate; DNA (acetylator polymorphism, alcohol dehydrogenase, alpha 1-antitrypsin, cystic fibrosis, Duchenne/Becker muscular dystrophy, glucose-6-phosphate dehydrogenase, hemoglobin A, hemoglobin S, hemoglobin C, hemoglobin D, hemoglobin E, hemoglobin F, D-Punjab, beta-thalassemia, hepatitis B virus, HCMV, HIV-1, HTLV-1, Leber hereditary optic neuropathy, MCAD, RNA, PKU, Plasmodium vivax, sexual differentiation, 21-deoxycortisol); desbutylhalofantrine; dihydropteridine reductase; diptheria/tetanus antitoxin; erythrocyte arginase; erythrocyte protoporphyrin; esterase D; fatty acids/acylglycines; free β-human chorionic gonadotropin; free erythrocyte porphyrin; free thyroxine (FT4); free tri-iodothyronine (FT3); fumarylacetoacetase; galactose/gal-1-phosphate; galactose-1-phosphate uridyltransferase; gentamicin; glucose-6-phosphate dehydrogenase; glutathione; glutathione perioxidase; glycocholic acid; glycosylated hemoglobin; halofantrine; hemoglobin variants; hexosaminidase A; human erythrocyte carbonic anhydrase I; 17-alpha-hydroxyprogesterone; hypoxanthine phosphoribosyl transferase; immunoreactive trypsin; lactate; lead; lipoproteins ((a), B/A-1, β); lysozyme; mefloquine; netilmicin; phenobarbitone; phenytoin; phytanic/pristanic acid; progesterone; prolactin; prolidase; purine nucleoside phosphorylase; quinine; reverse tri-iodothyronine (rT3); selenium; serum pancreatic lipase; sissomicin; somatomedin C; specific antibodies (adenovirus, anti-nuclear antibody, anti-zeta antibody, arbovirus, Aujeszky's disease virus, dengue virus, Dracunculus medinensis, Echinococcus granulosus, Entamoeba histolytica, enterovirus, Giardia duodenalisa, Helicobacter pylori, hepatitis B virus, herpes virus, HIV-1, IgE (atopic disease), influenza virus, Leishmania donovani, leptospira, measles/mumps/rubella, Mycobacterium leprae, Mycoplasma pneumoniae, Myoglobin, Onchocerca volvulus, parainfluenza virus, Plasmodium falciparum, poliovirus, Pseudomonas aeruginosa, respiratory syncytial virus, rickettsia (scrub typhus), Schistosoma mansoni, Toxoplasma gondii, Trepenoma pallidium, Trypanosoma cruzi/rangeli, vesicular stomatis virus, Wuchereria bancrofti, yellow fever virus); specific antigens (hepatitis B virus, HIV-1); succinylacetone; sulfadoxine; theophylline; thyrotropin (TSH); thyroxine (T4); thyroxine-binding globulin; trace elements; transferrin; UDP-galactose-4-epimerase; urea; uroporphyrinogen I synthase; vitamin A; white blood cells; and zinc protoporphyrin. Salts, sugar, protein, fat, vitamins and hormones naturally occurring in blood or interstitial fluids can also constitute analytes in certain embodiments. The analyte can be naturally present in the biological fluid, for example, a metabolic product, a hormone, an antigen, an antibody, and the like. Alternatively, the analyte can be introduced into the body, for example, a contrast agent for imaging, a radioisotope, a chemical agent, a fluorocarbon-based synthetic blood, or a drug or pharmaceutical composition, including but not limited to insulin; ethanol; cannabis (marijuana, tetrahydrocannabinol, hashish); inhalants (nitrous oxide, amyl nitrite, butyl nitrite, chlorohydrocarbons, hydrocarbons); cocaine (crack cocaine); stimulants (amphetamines, methamphetamines, Ritalin, Cylert, Preludin, Didrex, PreState, Voranil, Sandrex, Plegine); depressants (barbituates, methaqualone, tranquilizers such as Valium, Librium, Miltown, Serax, Equanil, Tranxene); hallucinogens (phencyclidine, lysergic acid, mescaline, peyote, psilocybin); narcotics (heroin, codeine, morphine, opium, meperidine, Percocet, Percodan, Tussionex, Fentanyl, Darvon, Talwin, Lomotil); designer drugs (analogs of fentanyl, meperidine, amphetamines, methamphetamines, and phencyclidine, for example, Ecstasy); anabolic steroids; and nicotine. The metabolic products of drugs and pharmaceutical compositions are also contemplated analytes. Analytes such as neurochemicals and other chemicals generated within the body can also be analyzed, such as, for example, ascorbic acid, uric acid, dopamine, noradrenaline, 3-methoxytyramine (3MT), 3,4-dihydroxyphenylacetic acid (DOPAC), homovanillic acid (HVA), 5-hydroxytryptamine (5HT), and 5-hydroxyindoleacetic acid (FHIAA).

The terms “operable connection,” “operably connected,” and “operably linked” as used herein are broad terms and are used in their ordinary sense, including, without limitation, one or more components linked to another component(s) in a manner that allows transmission of signals between the components. For example, one or more electrodes can be used to detect the amount of analyte in a sample and convert that information into a signal; the signal can then be transmitted to a circuit. In this case, the electrode is “operably linked” to the electronic circuitry.

The term “host” as used herein is a broad term and is used in its ordinary sense, including, without limitation, mammals, particularly humans.

The terms “electrochemically reactive surface” and “electroactive surface” as used herein are broad terms and are used in their ordinary sense, including, without limitation, the surface of an electrode where an electrochemical reaction takes place. As one example, a working electrode measures hydrogen peroxide produced by the enzyme catalyzed reaction of the analyte being detected reacts creating an electric current (for example, detection of glucose analyte utilizing glucose oxidase produces H₂O₂ as a by product, H₂O₂ reacts with the surface of the working electrode producing two protons (2H⁺), two electrons (2e⁻) and one molecule of oxygen (O₂) which produces the electronic current being detected). At the counter electrode, a reducible species, for example, O₂ is reduced at the electrode surface in order to balance the current being generated by the working electrode.

The term “sensing region” as used herein is a broad term and is used in its ordinary sense, including, without limitation, the region of a monitoring device responsible for the detection of a particular analyte. The sensing region generally comprises a non-conductive body, a working electrode, a reference electrode, and/or a counter electrode (optional) passing through and secured within the body, forming electrochemically reactive surfaces on the body, and an electronic connective means at another location on the body, and a multi-domain membrane affixed to the body and covering the electrochemically reactive surface.

The term “electronic connection” as used herein is a broad term and is used in its ordinary sense, including, without limitation, any electronic connection known to those in the art that can be utilized to interface the sensing region electrodes with the electronic circuitry of a device such as mechanical (for example, pin and socket) or soldered.

The term “EEPROM,” as used herein, is a broad term and is used in its ordinary sense, including, without limitation, electrically erasable programmable read-only memory, which is user-modifiable read-only memory (ROM) that can be erased and reprogrammed (for example, written to) repeatedly through the application of higher than normal electrical voltage.

The term “SRAM,” as used herein, is a broad term and is used in its ordinary sense, including, without limitation, static random access memory (RAM) that retains data bits in its memory as long as power is supplied.

The term “A/D Converter,” as used herein, is a broad term and is used in its ordinary sense, including, without limitation, hardware and/or software that converts analog electrical signals into corresponding digital signals.

The term “microprocessor,” as used herein, is a broad term and is used in its ordinary sense, including, without limitation a computer system or processor designed to perform arithmetic and logic operations using logic circuitry that responds to and processes the basic instructions that drive a computer.

The term “RF transceiver,” as used herein, is a broad term and is used in its ordinary sense, including, without limitation, a radio frequency transmitter and/or receiver for transmitting and/or receiving signals.

The terms “raw data stream” and “data stream,” as used herein, are broad terms and are used in their ordinary sense, including, without limitation, an analog or digital signal directly related to the measured glucose from the glucose sensor. In one example, the raw data stream is digital data in “counts” converted by an A/D converter from an analog signal (for example, voltage or amps) representative of a glucose concentration. The terms broadly encompass a plurality of time spaced data points from a substantially continuous glucose sensor, which comprises individual measurements taken at time intervals ranging from fractions of a second up to, for example, 1, 2, or 5 minutes or longer.

The term “counts,” as used herein, is a broad term and is used in its ordinary sense, including, without limitation, a unit of measurement of a digital signal. In one example, a raw data stream measured in counts is directly related to a voltage (for example, converted by an A/D converter), which is directly related to current from the working electrode. In another example, counter electrode voltage measured in counts is directly related to a voltage.

The term “potentiostat,” as used herein, is a broad term and is used in its ordinary sense, including, without limitation, an electrical system that controls the potential between the working and reference electrodes of an electrochemical cell at a preset value. In one example of a three electrode cell, it forces whatever current is necessary to flow between the working and counter electrodes to keep the desired potential, as long as the cell voltage and current do not exceed the compliance limits of the potentiostat.

The term “electrical potential,” as used herein, is a broad term and is used in its ordinary sense, including, without limitation, the electrical potential difference between two points in a circuit which is the cause of the flow of a current.

The term “ischemia,” as used herein, is a broad term and is used in its ordinary sense, including, without limitation, local and temporary deficiency of blood supply due to obstruction of circulation to a part (for example, sensor). Ischemia can be caused by mechanical obstruction (for example, arterial narrowing or disruption) of the blood supply, for example.

The term “system noise,” as used herein, is a broad term and is used in its ordinary sense, including, without limitation, unwanted electronic or diffusion-related noise including Gaussian, motion-related, flicker, kinetic, and other white noise, for example.

The terms “signal artifacts” and “transient non-glucose related signal artifacts that have a higher amplitude than system noise,” as used herein, are broad terms and are used in their ordinary sense, including, without limitation, signal noise that is caused by substantially non-glucose reaction rate-limiting phenomena, such as ischemia, pH changes, temperature changes, pressure, and stress, for example. Signal artifacts, as described herein, are typically transient and characterized by a higher amplitude than system noise.

The terms “low noise,” as used herein, is a broad term and is used in its ordinary sense, including, without limitation, noise that substantially decreases signal amplitude.

The terms “high noise” and “high spikes,” as used herein, are broad terms and are used in their ordinary sense, including, without limitation, noise that substantially increases signal amplitude.

The term “frequency content,” as used herein, is a broad term and is used in its ordinary sense, including, without limitation, the spectral density, including the frequencies contained within a signal and their power.

The term “pulsed amperometric detection,” as used herein, is a broad term and is used in its ordinary sense, including, without limitation, an electrochemical flow cell and a controller, which cyclically applies different potentials and monitors current generated by the electrochemical reactions at one or more of the potentials. The cell can include one or multiple working electrodes at different applied potentials.

As employed herein, the following abbreviations apply: Eq and Eqs (equivalents); mEq (milliequivalents); M (molar); mM (millimolar) μM (micromolar); N (Normal); mol (moles); mmol (millimoles); μmol (micromoles); nmol (nanomoles); g (grams); mg (milligrams); μg (micrograms); Kg (kilograms); L (liters); mL (milliliters); dL (deciliters); μL (microliters); cm (centimeters); mm (millimeters); μm (micrometers); nm (nanometers); h and hr (hours); min. (minutes); s and sec. (seconds); ° C. (degrees Centigrade).

Overview

The preferred embodiments relate to the use of a sensor that measures a concentration of an analyte of interest or a substance indicative of the concentration or presence of the analyte in bodily fluid. In some embodiments, the sensor is a continuous device, for example a subcutaneous, transdermal, or intravascular device. In some embodiments, the device can analyze a plurality of intermittent blood samples.

The sensor uses any known method, including invasive, minimally invasive, and non-invasive sensing techniques, to provide an output signal indicative of the concentration of the analyte of interest. The sensor is of the type that senses a product or reactant of an enzymatic reaction between an analyte and an enzyme in the presence of oxygen as a measure of the analyte in vivo or in vitro. Such a sensor typically comprises a membrane surrounding the enzyme through which a bodily fluid passes and in which an analyte within the bodily fluid reacts with the enzyme in the presence of oxygen to generate a product. The product is then measured using electrochemical methods and thus the output of an electrode system functions as a measure of the analyte. In some embodiments, the sensor can use amperometric, coulometric, conductimetric, and/or potentiometric techniques for measuring the analyte. In some embodiments, the electrode system can be used with any of a variety of known in vitro or in vivo analyte sensors or monitors, such as are described in U.S. Pat. No. 6,001,067 to Shults et al.; U.S. Pat. No. 6,702,857 to Brauker et al.; U.S. Pat. No. 6,212,416 to Ward et al.; U.S. Pat. No. 6,119,028 to Schulman et al.; U.S. Pat. No. 6,400,974 to Lesho; U.S. Pat. No. 6,595,919 to Berner et al.; U.S. Pat. No. 6,141,573 to Kurnik et al.; U.S. Pat. No. 6,122,536 to Sun et al.; European Patent Application EP 1153571 to Varall et al.; U.S. Pat. No. 6,512,939 to Colvin et al.; U.S. Pat. No. 5,605,152 to Slate et al.; U.S. Pat. No. 4,431,004 to Bessman et al.; U.S. Pat. No. 4,703,756 to Gough et al.; U.S. Pat. No. 6,514,718 to Heller et al.; U.S. patent to U.S. Pat. No. 5,985,129 to Gough et al.; WO Patent Application Publication No. 2004/021877 to Caduff; U.S. Pat. No. 5,494,562 to Maley et al.; U.S. Pat. No. 6,120,676 to Heller et al.; and U.S. Pat. No. 6,542,765 to Guy et al., the contents of each of which are hereby incorporated by reference in their entireties.

Sensor

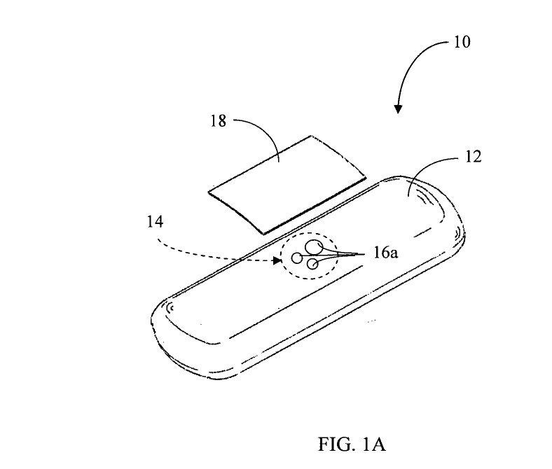

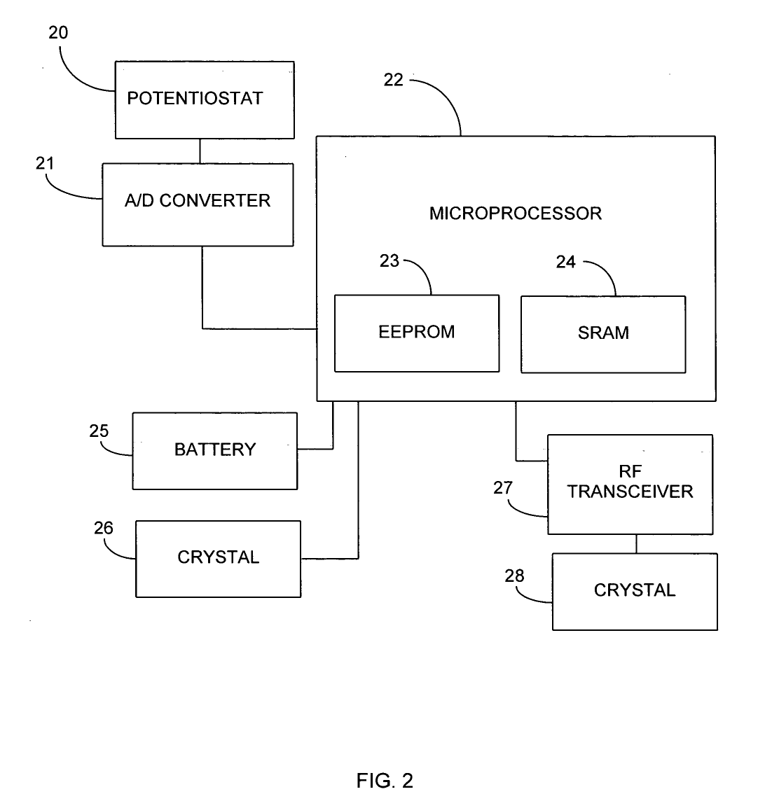

FIG. 1 is an exploded perspective view of one exemplary embodiment comprising an implantable glucose sensor 10 that utilizes amperometric electrochemical sensor technology to measure glucose. In this exemplary embodiment, a body 12 with a sensing region 14 including an electrode system 16 and sensor electronics, which are described in more detail with reference to FIG. 2.

In this embodiment, the electrode system 16 is operably connected to the sensor electronics (FIG. 2) and includes electroactive surfaces, which are covered by a membrane system 18. The membrane system 18 is disposed over the electroactive surfaces of the electrode system 16 and provides one or more of the following functions: 1) protection of the exposed electrode surface from the biological environment; 2) diffusion resistance (limitation) of the analyte; 3) a catalyst for enabling an enzymatic reaction; 4) limitation or blocking of interfering species; and 5) hydrophilicity at the electrochemically reactive surfaces of the sensor interface, for example, such as is described in co-pending U.S. patent application Ser. No. 10/838,912, filed May 3, 2004 and entitled “IMPLANTABLE ANALYTE SENSOR,” the contents of which are incorporated herein by reference in their entirety. The membrane system can be attached to the sensor body 12 by mechanical or chemical methods such as are described in co-pending U.S. patent application MEMBRANE ATTACHMENT and U.S. patent application Ser. No. 10/838,912 filed May 3, 2004 and entitled, “IMPLANTABLE ANALYTE SENSOR”, the contents of which are incorporated herein by reference in their entireties.

In some embodiments, the electrode system 16, which is located on or within the sensing region 14, is comprised of at least a working and a reference electrode with an insulating material disposed therebetween. In some alternative embodiments, additional electrodes can be included within the electrode system, for example, a three-electrode system (working, reference, and counter electrodes) and/or an additional working electrode (which can be used to generate oxygen, measure an additional analyte, or can be configured as a baseline subtracting electrode, for example).

In the illustrated embodiment, the electrode system includes three electrodes (working, counter, and reference electrodes), wherein the counter electrode is provided to balance the current generated by the species being measured at the working electrode. In a glucose oxidase based glucose sensor, the species measured at the working electrode is H₂O₂. Glucose oxidase, GOX, catalyzes the conversion of oxygen and glucose to hydrogen peroxide and gluconate according to the following reaction:
GOX+Glucose+O₂→Gluconate+H₂O₂+reduced GOX

The change in H₂O₂ can be monitored to determine glucose concentration because for each glucose molecule metabolized, there is a proportional change in the product H₂O₂. Oxidation of H₂O₂ by the working electrode is balanced by reduction of ambient oxygen, enzyme generated H₂O₂, or other reducible species at the counter electrode. The H₂O₂ produced from the glucose oxidase reaction further reacts at the surface of working electrode and produces two protons (2H+), two electrons (2e−), and one oxygen molecule (O2). In such embodiments, because the counter electrode utilizes oxygen as an electron acceptor, the most likely reducible species for this system is oxygen or enzyme generated peroxide. There are two main pathways by which oxygen can be consumed at the counter electrode. These pathways include a four-electron pathway to produce hydroxide and a two-electron pathway to produce hydrogen peroxide. In addition to the counter electrode, oxygen is further consumed by the reduced glucose oxidase within the enzyme layer. Therefore, due to the oxygen consumption by both the enzyme and the counter electrode, there is a net consumption of oxygen within the electrode system. Theoretically, in the domain of the working electrode there is significantly less net loss of oxygen than in the region of the counter electrode. In some electrochemical cell configurations, there is a close correlation between the ability of the counter electrode to maintain current balance and sensor function. In some sensor configurations, it is believed that that counter electrode function becomes limited before the enzyme reaction becomes limited when oxygen concentration is lowered.

In general, in electrochemical sensors wherein an enzymatic reaction depends on oxygen as a co-reactant, depressed function or inaccuracy can be experienced in low oxygen environments, for example, in vivo. Subcutaneously implanted sensors are especially susceptible to transient ischemia that can compromise sensor function. For example, because of the enzymatic reaction required for an implantable amperometric glucose sensor, oxygen must be in excess over glucose at the sensor in order for it to effectively function as a glucose sensor. If glucose becomes in excess, the sensor turns into an oxygen sensitive device. In vivo, glucose concentration can vary from about one hundred times or more than that of the oxygen concentration. Consequently, oxygen becomes a limiting reactant in the electrochemical reaction and when insufficient oxygen is provided to the sensor, the sensor is unable to accurately measure glucose concentration. Those skilled in the art interpret oxygen limitations resulting in depressed function or inaccuracy as a problem of availability of oxygen to the enzyme. Oxygen limitations can also be seen during periods of transient ischemia that occur, for example, under certain postures or when the region around the implanted sensor is compressed so that blood is forced out of the capillaries. Such ischemic periods observed in implanted sensors can last for many minutes or even an hour or longer.

Consequently, one limitation of conventional enzymatic analyte sensors can be caused by oxygen deficiencies. When oxygen is deficient relative to the amount of glucose (in the example of an enzymatic glucose sensor), then the enzymatic reaction is limited by oxygen rather than glucose. Thus, the output signal is indicative of the oxygen concentration rather than the glucose concentration, producing erroneous signals.

In contrast to the prior art, the sensors of preferred embodiments advantageously generate oxygen to allow the sensor to function in sufficient oxygen levels independent of (or with minimal effect from) the oxygen concentration in the surrounding environment, which is described in more detail below.

Sensor Electronics

FIG. 2 is a block diagram that illustrates one possible configuration of the sensor electronics in one embodiment; however a variety of sensor electronics configurations can be implemented with the preferred embodiments. In this embodiment, a potentiostat 20 is shown, which is operatively connected to electrode system 16 (FIG. 1) to obtain a current value, and includes a resistor (not shown) that translates the current into voltage. The A/D converter 21 digitizes the analog signal into “counts” for processing. Accordingly, the resulting raw data signal in counts is directly related to the current measured by the potentiostat.

A microprocessor 22 is the central control unit that houses EEPROM 23 and SRAM 24, and controls the processing of the sensor electronics. The alternative embodiments can utilize a computer system other than a microprocessor to process data as described herein. In some alternative embodiments, an application-specific integrated circuit (ASIC) can be used for some or all the sensor's central processing. EEPROM 23 provides semi-permanent storage of data, storing data such as sensor ID and programming to process data signals (for example, programming for data smoothing such as described elsewhere herein). SRAM 24 is used for the system's cache memory, for example for temporarily storing recent sensor data.

The battery 25 is operatively connected to the microprocessor 22 and provides the power for the sensor. In one embodiment, the battery is a Lithium Manganese Dioxide battery, however any appropriately sized and powered battery can be used. In some embodiments, a plurality of batteries can be used to power the system. Quartz Crystal 26 is operatively connected to the microprocessor 22 and maintains system time for the computer system.

The RF Transceiver 27 is operably connected to the microprocessor 22 and transmits the sensor data from the sensor to a receiver. Although a RF transceiver is shown here, some other embodiments can include a wired rather than wireless connection to the receiver. In yet other embodiments, the sensor can be transcutaneously connected via an inductive coupling, for example. The quartz crystal 28 provides the system time for synchronizing the data transmissions from the RF transceiver. The transceiver 27 can be substituted with a transmitter in one embodiment.

Although FIGS. 1 and 2 and associated text illustrate and describe one exemplary embodiment of an implantable glucose sensor, the electrode system, electronics and its method of manufacture of the preferred embodiments described below can be implemented on any known electrochemical sensor, including those disclosed in co-pending U.S. patent application Ser. No. 10/838,912 filed May 3, 2004 and entitled, “IMPLANTABLE ANALYTE SENSOR”; U.S. patent application Ser. No. 10/789,359 filed Feb. 26, 2004 and entitled, “INTEGRATED DELIVERY DEVICE FOR A CONTINUOUS GLUCOSE SENSOR”; “OPTIMIZED SENSOR GEOMETRY FOR AN IMPLANTABLE GLUCOSE SENSOR”; and U.S. application Ser. No. 10/633,367 filed Aug. 1, 2003 entitled, “SYSTEM AND METHODS FOR PROCESSING ANALYTE SENSOR DATA”, the contents of each of which are hereby incorporated herein by reference in their entireties.

Electrode System

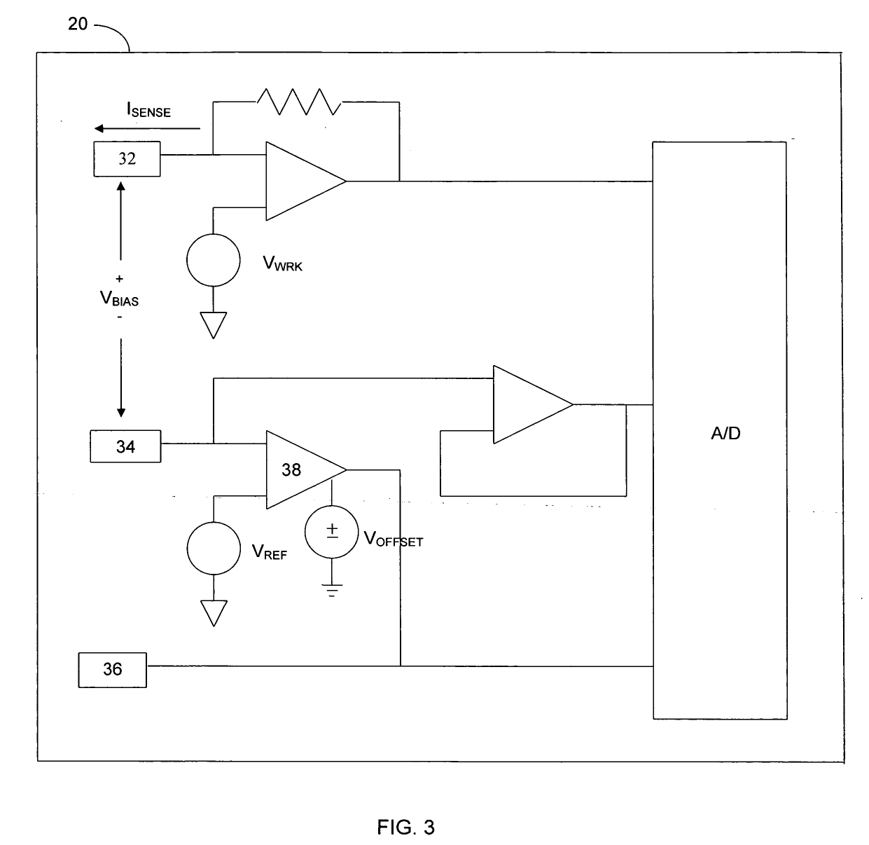

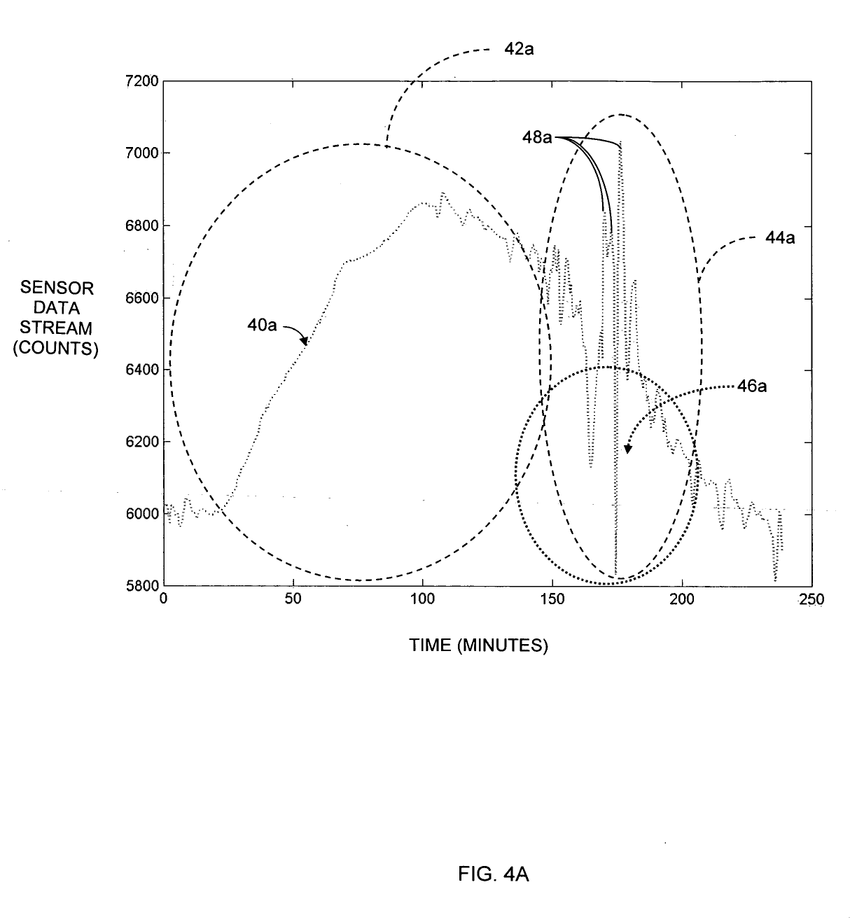

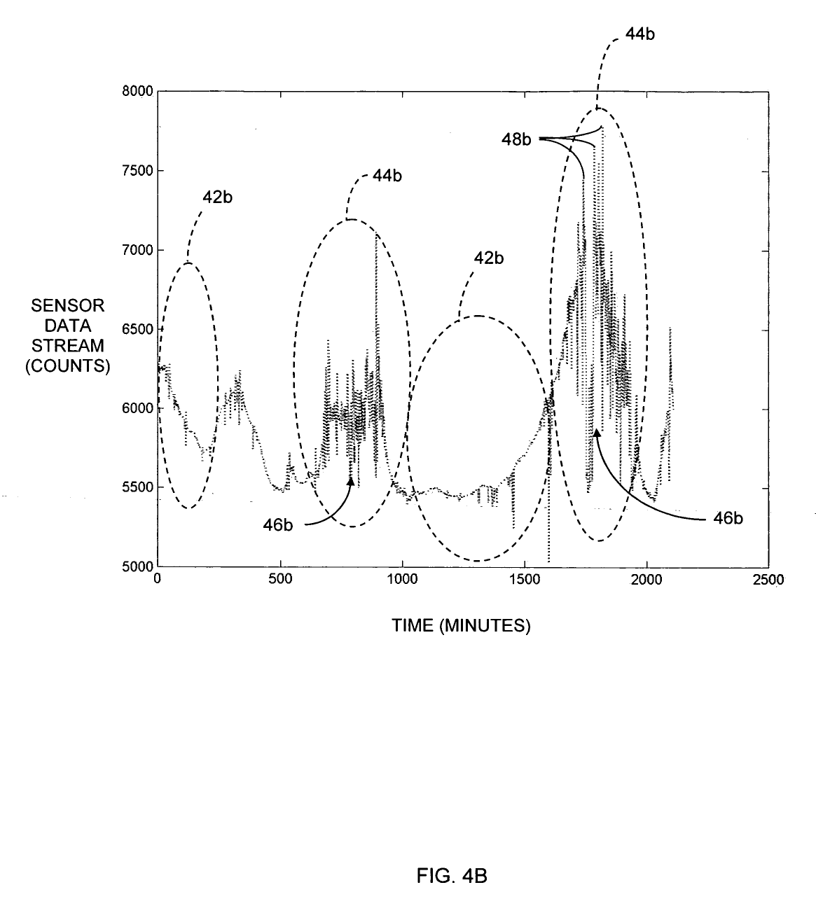

Reference is now made to FIG. 3, which is a circuit diagram of a potentiostat 20 configured to control the three-electrode system 16 described with reference to FIGS. 1 and 2, above. The potentiostat 20 is employed to monitor the electrochemical reaction at the electroactive surface(s) by applying a constant potential to the working and reference electrodes to determine a current value. The current that is produced at the working electrode (and flows through the circuitry to the counter electrode) is substantially proportional to the amount of H₂O₂ that diffuses to the working electrode. Accordingly, a raw signal (see FIGS. 4A and 4B) can be produced that is representative of the concentration of glucose in the user's body, and therefore can be utilized to estimate a meaningful glucose value.

In one embodiment, the potentiostat includes electrical connections to the working electrode 32, the reference electrode 34, and the counter electrode 36. The voltage applied to the working electrode 32 is a constant value and the voltage applied to the reference electrode is also set at a constant value such that the potential (V_{BIAS}) applied between the working and reference electrodes is maintained at a constant value. The counter electrode 26 is configured to have a constant current (equal to the current being measured by the working electrode 32), which is accomplished by varying the voltage at the counter electrode in order to balance the current going through the working electrode 32 such that current does not pass through the reference electrode 34. A negative feedback loop 38 is constructed from an operational amplifier (OP AMP), the reference electrode 34, the counter electrode 36, and a reference potential (V_{REF}), to maintain the reference electrode at a constant voltage.

As described in more detail above, many electrochemical sensors face a challenge in maintaining sensor output during ischemic conditions, which can occur, for example, either as short-term transient events in vivo (for example, compression caused by postural effects on the device) or as long-term low oxygen conditions in vivo (for example, caused by a thickened FBC or by barrier cells). When the sensor is in a low oxygen environment, the potentiostat reacts by decreasing the voltage relative to the reference electrode voltage applied to the counter electrode, which can result in other less electro-active species reacting at the counter electrode.

Accordingly, the preferred embodiments involve setting the bias (V_{BIAS}), also referred to as the applied potential (for example, voltage difference between working and reference electrodes), of the sensor to a level where a continuous background level of oxygen is produced in reactions with water or other electroactive species, which is in contrast to conventional electrochemical systems that typically set their bias at a level such that the sensing (working) electrode measures a signal only from the product of the enzyme reaction. In the example of a glucose sensor such as described above, a bias setting of about +0.6 V has conventionally been used to successfully oxidize and measure H₂O₂ without oxidizing and measuring water or other electroactive species (See, e.g., U.S. Pat. No. 5,411,647 to Johnson, et al.)

However, the preferred embodiments typically employ an increased bias potential setting in an electrode system such that the working electrode not only successfully oxidizes and measures H₂O₂, but also additionally oxidizes and measures water or other electroactive species. In one example, the bias setting can be increased by about 0.05 V to about 0.4 V above what is necessary for sufficient H₂O₂ measurements, for example. The products of the water electrolysis reaction (and some other electroactive species) are oxygen at the working electrode and hydrogen at the counter electrode. The oxygen produced at the working electrode diffuses in all directions including up to the glucose oxidase directly above the working electrode and also over to the surface of the counter electrode. This production of oxygen at the working electrode allows increased sensor function even in low oxygen environments.

An increased bias potential, which results in increased oxidation, also increases the current measured by the working electrode. However, it is believed that the increased bias potential is substantially linear and measurable; therefore, the increased bias potential will not affect the measurability of the analyte of interest (for example, glucose).

In some embodiments, the bias is continuously set at a desired bias, for example, between about +0.65 and about +1.2 Volts, in order to continuously oxidize and/or measure water or other electroactive species. In some alternative embodiments, the potentiostat can be configured to incrementally switch between a plurality of different bias settings, for example the bias can be switched between a first bias setting and a second bias setting at regular intervals or during break-in or system start-up. In one such example, the first bias setting (for example, +0.6V) measures a signal only from the product of the enzyme reaction, however at certain predetermined times (for example, during a system break-in period of between about 1 hour and 3 days), the potentiostat is configured to switch to the second bias setting (for example, +1.0V) that oxidizes and measures water or other electroactive species.

In some additional alternative embodiments, the potentiostat can be configured to selectively or variably switch between two or more bias settings based on a variety of conditions, such as oxygen concentration, signal noise, signal sensitivity, baseline shifts, or the like. In one such example, a first bias setting (for example, +0.6V) measures a signal only from the product of the enzyme reaction, however, when oxygen limitations are detected, the system is configured to switch to a second bias setting (for example, +0.8V) to oxidize water or other electroactive species in order to generate usable oxygen.

In some additional alternative embodiments, pulsed amperometric detection is employed to incrementally and/or cyclically switch between a plurality of different bias settings. In one such example, the controller is configured to hold an optimized oxygen-generating potential (for example, +1.0V) except during analyte measurements, during which the controller is configured to switch to an optimized analyte-sensing potential (for example, +0.6V) for a time period sufficient to measure the analyte. An appropriate “break-in” time period and/or a temporarily lower potential (+0.4V) can be implemented to ensure accurate analyte measurements are obtained, as is appreciated by one skilled in the art. A variety of systems and methods can be used for detecting oxygen limitations, such as signal artifact detection, oxygen monitoring, signal sensitivity, baseline shifts, or the like, which are described in more detail below.

FIGS. 4A and 4B are graphs of raw data streams from a conventional implantable glucose sensor. FIG. 4A is a graph that shows a raw data stream 40a obtained from a glucose sensor over an approximately 4 hour time span in one example. FIG. 4B is a graph that shows a raw data stream 40b obtained from a glucose sensor over an approximately 36 hour time span in another example. The x-axis represents time in minutes. The y-axis represents sensor data in counts. In these examples, sensor output in counts is transmitted every 30-seconds.

Sections 42a, 42b of the data streams of FIGS. 4A and 4B, respectively, illustrate time periods during which some system noise can be seen on the data stream. This system noise can be characterized as Gaussian, Brownian, and/or linear noise, and can be substantially normally distributed about the mean. The system noise is likely electronic and diffusion-related, or the like, and can be smoothed using techniques such as by using an FIR filter. The glucose data of the data streams 40a, 40b such as shown in sections 42a, 42b is a fairly accurate representation of glucose concentration and can be confidently used to report glucose concentration to the user when appropriately calibrated.

The “signal artifacts” such as shown in sections 44a, 44b of the data streams 40a, 40b illustrate time periods during which “signal artifacts” can be seen, which are significantly different from the previously described system noise (sections 42a, 42b). This noise, such as shown in section 44a and 44b, is referred to herein as “signal artifacts” and more particularly described as “transient non-glucose dependent signal artifacts that have a higher amplitude than system noise.” At times, signal artifacts comprise low noise, which generally refers to noise that substantially decreases signal amplitude 46a, 46b herein, which is best seen in the signal artifacts 44b of FIG. 4B. Occasional high spikes 48a, 48b, which generally correspond to noise that substantially increases signal amplitude, can also be seen in the signal artifacts, which generally occur after a period of low noise. These high spikes are generally observed after transient low noise and typically result after reaction rate-limiting phenomena occur. For example, in an embodiment where a glucose sensor requires an enzymatic reaction, local ischemia creates a reaction that is rate-limited by oxygen, which is responsible for low noise. In this situation, glucose is expected to build up in the membrane because it is not completely catabolized during the oxygen deficit. When oxygen is again in excess, there is also excess glucose due to the transient oxygen deficit. The enzyme reacts to completion until the excess glucose is catabolized, resulting in high noise.

Analysis of signal artifacts such as shown in sections 44a, 44b of FIGS. 4A and 4B, respectively, indicates that the observed low noise is caused by substantially non-glucose reaction dependent phenomena, such as ischemia that occurs within or around a glucose sensor in vivo, for example, which results in the reaction becoming oxygen dependent. As a first example, at high glucose levels, oxygen can become limiting to the enzymatic reaction, resulting in a non-glucose dependent downward trend in the data (best seen in FIG. 4B). As a second example, certain movements or postures taken by the patient can cause transient downward noise as blood is squeezed out of the capillaries resulting in local ischemia, and causing non-glucose dependent low noise. Because excess oxygen (relative to glucose) is necessary for proper sensor function, transient ischemia can result in a loss of signal gain in the sensor data. In this second example oxygen can also become transiently limited due to contracture of tissues around the sensor interface. This is similar to the blanching of skin that can be observed when one puts pressure on it. Under such pressure, transient ischemia can occur in both the epidermis and subcutaneous tissue. Transient ischemia is common and well tolerated by subcutaneous tissue.

Accordingly, in some embodiments the system is configured to detect oxygen limitations by analysis of signal artifacts. Co-pending U.S. patent application Ser. No. 10/648,849 filed Aug. 22, 2003 and entitled, “SYSTEMS AND METHODS FOR REPLACING SIGNAL ARTIFACTS IN A GLUCOSE SENSOR DATA STREAM,” which is incorporated herein by reference in its entirety, describes a variety of systems and methods for detecting signal artifacts; for example, by pulsed amperometric detection, monitoring the counter electrode, monitoring the reference electrode, detecting a non-physiological rate-of-change, and monitoring the frequency content of the signal.

In some alternative embodiments, oxygen monitoring is used to detect whether oxygen limitations at or near the electrochemical sensor exist. Detecting oxygen concentration and determining if an oxygen limitation exists can be used to trigger certain bias settings. A variety of methods can be used to test for oxygen. For example, an oxygen-sensing electrode, or other oxygen sensor can be employed. The measurement of oxygen concentration can be sent to a microprocessor, which determines if the oxygen concentration indicates ischemia.

In some embodiments, wherein oxygen monitoring is employed, an oxygen sensor is placed proximal to or within a glucose sensor. For example, the oxygen sensor can be located on or near the glucose sensor such that their respective local environments are shared and oxygen concentration measurement from the oxygen sensor represents an accurate measurement of the oxygen concentration on or within the glucose sensor. In some alternative embodiments, an oxygen sensor is also placed distal to the glucose sensor. For example, the oxygen sensor can be located sufficiently far from the glucose sensor such that their respective local environments are not shared and oxygen measurements from the proximal and distal oxygen sensors can be compared to determine the relative difference between the respective local environments. By comparing oxygen concentration proximal and distal oxygen sensor, change in local (proximal) oxygen concentration can be determined from a reference (distal) oxygen concentration.

Oxygen sensors are useful for a variety of purposes. For example, U.S. Pat. No. 6,512,939 to Colvin et al., the contents of which are incorporated herein by reference in their entirety, discloses an oxygen sensor that measures background oxygen levels. However, Colvin et al. rely on the oxygen sensor for the data stream of glucose measurements by subtraction of oxygen remaining after exhaustion of glucose by an enzymatic reaction from total unreacted oxygen concentration.

In some other alternative embodiments, the sensitivity of the data signal is monitored to determine appropriate bias settings. The term “sensitivity” as used herein is a broad term and is used in its ordinary sense, including, without limitation, relative signal strength measured from the analyte sensor with respect to a measured analyte concentration (not including baseline). For example, in a glucose sensor the number of “counts” measured by the sensor as compared to the glucose concentration measured by a reference blood glucose meter. In some embodiments, the amplitude of the signal, such as the amplitude when a low sensitivity is detected, can be indicative of oxygen limitations. In some embodiments, a variability of sensor sensitivity (above a certain threshold) can be indicative of oxygen limitations.

Therefore, the sensors of preferred embodiments produce oxygen for the enzyme layer and also for the counter electrode and can be implemented in an electrode system simply by modifying the bias potential of the electrode system of an electrochemical sensor.

Methods and devices that are suitable for use in conjunction with aspects of the preferred embodiments are disclosed in co-pending U.S. patent application Ser. No. 10/842,716, filed May 10, 2004 and entitled, “BIOINTERFACE MEMBRANES INCORPORATING BIOACTIVE AGENTS”; co-pending U.S. patent application Ser. No. 10/838,912 filed May 3, 2004 and entitled, “IMPLANTABLE ANALYTE SENSOR”; U.S. patent application Ser. No. 10/789,359 filed Feb. 26, 2004 and entitled, “INTEGRATED DELIVERY DEVICE FOR A CONTINUOUS GLUCOSE SENSOR”; U.S. application Ser. No. 10/685,636 filed Oct. 28, 2003 and entitled, “SILICONE COMPOSITION FOR BIOCOMPATIBLE MEMBRANE”; U.S. application Ser. No. 10/648,849 filed Aug. 22, 2003 and entitled, “SYSTEMS AND METHODS FOR REPLACING SIGNAL ARTIFACTS IN A GLUCOSE SENSOR DATA STREAM”; U.S. application Ser. No. 10/646,333 filed Aug. 22, 2003 entitled, “OPTIMIZED SENSOR GEOMETRY FOR AN IMPLANTABLE GLUCOSE SENSOR”; U.S. application Ser. No. 10/647,065 filed Aug. 22, 2003 entitled, “POROUS MEMBRANES FOR USE WITH IMPLANTABLE DEVICES”; U.S. application Ser. No. 10/633,367 filed Aug. 1, 2003 entitled, “SYSTEM AND METHODS FOR PROCESSING ANALYTE SENSOR DATA”; U.S. Pat. No. 6,702,857 entitled “MEMBRANE FOR USE WITH IMPLANTABLE DEVICES”; U.S. application Ser. No. 09/916,711 filed Jul. 27, 2001 and entitled “SENSOR HEAD FOR USE WITH IMPLANTABLE DEVICE”; U.S. application Ser. No. 09/447,227 filed Nov. 22, 1999 and entitled “DEVICE AND METHOD FOR DETERMINING ANALYTE LEVELS”; U.S. application Ser. No. 10/153,356 filed May 22, 2002 and entitled “TECHNIQUES TO IMPROVE POLYURETHANE MEMBRANES FOR IMPLANTABLE GLUCOSE SENSORS”; U.S. Pat. No. 6,741,877 entitled “DEVICE AND METHOD FOR DETERMINING ANALYTE LEVELS”; U.S. Pat. No. 6,558,321 entitled “SYSTEMS AND METHODS FOR REMOTE MONITORING AND MODULATION OF MEDICAL DEVICES”; and U.S. application Ser. No. 09/916,858 filed Jul. 27, 2001 and entitled “DEVICE AND METHOD FOR DETERMINING ANALYTE LEVELS,” as well as issued patents including U.S. Pat. No. 6,001,067 issued Dec. 14, 1999 and entitled “DEVICE AND METHOD FOR DETERMINING ANALYTE LEVELS”; U.S. Pat. No. 4,994,167 issued Feb. 19, 1991 and entitled “BIOLOGICAL FLUID MEASURING DEVICE”; U.S. Pat. No. 4,757,022 filed Jul. 12, 1988 and entitled “BIOLOGICAL FLUID MEASURING DEVICE”; U.S. Appl. No. 60/489,615 filed Jul. 23, 2003 and entitled “ROLLED ELECTRODE ARRAY AND ITS METHOD FOR MANUFACTURE”; U.S. Appl. No. 60/490,009 filed Jul. 25, 2003 and entitled “OXYGEN ENHANCING ENZYME MEMBRANE FOR ELECTROCHEMICAL SENSORS”; U.S. Appl. No. 60/490,208 filed Jul. 25, 2003 and entitled “ELECTRODE ASSEMBLY WITH INCREASED OXYGEN GENERATION”; U.S. Appl. No. 60/490,007 filed Jul. 25, 2003 and entitled “OXYGEN-GENERATING ELECTRODE FOR USE IN ELECTROCHEMICAL SENSORS”; U.S. application Ser. No. ______ filed on even date herewith and entitled “ROLLED ELECTRODE ARRAY AND ITS METHOD FOR MANUFACTURE”; U.S. application Ser. No. ______ filed on even date herewith and entitled “OXYGEN ENHANCING ENZYME MEMBRANE FOR ELECTROCHEMICAL SENSORS”; U.S. application Ser. No. ______ filed on even date herewith and entitled “ELECTRODE ASSEMBLY WITH INCREASED OXYGEN GENERATION”; U.S. application Ser. No. ______ filed on even date herewith and entitled “ELECTRODE SYSTEMS FOR ELECTROCHEMICAL SENSORS”. The foregoing applications and patents are hereby incorporated herein by reference in their entireties.

All references cited herein are incorporated herein by reference in their entireties. To the extent publications and patents or patent applications incorporated by reference contradict the disclosure contained in the specification, the specification is intended to supersede and/or take precedence over any such contradictory material.

The term “comprising” as used herein is synonymous with “including,” “containing,” or “characterized by,” and is inclusive or open-ended and does not exclude additional, unrecited elements or method steps.

All numbers expressing quantities of ingredients, reaction conditions, and so forth used in the specification and claims are to be understood as being modified in all instances by the term “about.” Accordingly, unless indicated to the contrary, the numerical parameters set forth in the specification and attached claims are approximations that can vary depending upon the desired properties sought to be obtained by the present invention. At the very least, and not as an attempt to limit the application of the doctrine of equivalents to the scope of the claims, each numerical parameter should be construed in light of the number of significant digits and ordinary rounding approaches.

The above description discloses several methods and materials of the present invention. This invention is susceptible to modifications in the methods and materials, as well as alterations in the fabrication methods and equipment. Such modifications will become apparent to those skilled in the art from a consideration of this disclosure or practice of the invention disclosed herein. Consequently, it is not intended that this invention be limited to the specific embodiments disclosed herein, but that it cover all modifications and alternatives coming within the true scope and spirit of the invention as embodied in the attached claims.

1. An electrochemical sensor for determining a presence or a concentration of an analyte in a fluid, the sensor comprising:
a working electrode comprising a conductive material; and
a reference electrode comprising a conductive material,
wherein the sensor is configured such that a bias potential can be applied between the working electrode and the reference electrode at a level such that the working electrode measures the concentration of the analyte and produces oxygen in a reaction with water or another electroactive species in the fluid.

2. The electrochemical sensor of claim 1, wherein the bias potential is from about 0.05 V to about 0.4 V above a level at which the working electrode measures a signal only from the analyte.

3. The electrochemical sensor of claim 1, wherein the bias potential is above about +0.6V.

4. The electrochemical sensor of claim 1, wherein the bias potential is above about +0.7V.

5. The electrochemical sensor of claim 1, wherein the bias potential is above about +0.8V.

6. The electrochemical sensor of claim 1, wherein the bias potential is above about +0.9V.

7. The electrochemical sensor of claim 1, wherein the sensor is configured to continuously adjust the bias potential so as to continuously produce oxygen in a reaction with water or another electroactive species in the fluid.

8. The electrochemical sensor of claim 1, wherein the sensor is configured to apply the bias at a plurality of different bias settings.

9. The electrochemical sensor of claim 1, wherein the sensor is configured to switch the bias potential between a plurality of different bias settings at increments.

10. The electrochemical sensor of claim 9, wherein the increments comprise regular intervals.

11. The electrochemical sensor of claim 9, wherein the increments comprise a system break-in period.

12. The electrochemical sensor of claim 8, wherein the sensor is configured to switch the bias potential between a plurality of different bias settings based on a condition.

13. The electrochemical sensor of claim 12, wherein the condition comprises at least one of oxygen concentration, signal noise, signal sensitivity, and baseline shifts.

14. A method for generating oxygen by an electrochemical analyte sensor, the method comprising:
providing an electrochemical cell comprising a working electrode and a reference electrode;
applying a bias potential between the working electrode and the reference electrode, whereby the working electrode measures the concentration of an analyte and produces oxygen in a reaction with water or another electroactive species in the fluid.

15. The method of claim 14, wherein the bias potential is from about 0.05 V to about 0.4 V above a level at which the working electrode measures a signal only from the analyte.

16. The method of claim 14, wherein the bias potential is above about +0.6V.

17. The method of claim 14, wherein the bias potential is above about +0.7V.

18. The method of claim 14, wherein the bias potential is above about +0.8V.

19. The method of claim 14, wherein the bias potential is above about +0.9V.

20. The method of claim 14, wherein the bias potential is continuously applied.

21. The method of claim 20, wherein the step of applying the bias potential comprises applying a plurality of different bias potentials.

22. The method of claim 21, wherein the step of applying the bias potential comprises incrementally applying a plurality of different bias potentials.

23. The method of claim 22, wherein the step of applying the bias potential comprises applying a plurality of different bias potentials at regular intervals.

24. The method of claim 22, wherein the step of applying the bias potential comprises applying a plurality of different bias potentials for a system break-in period.

25. The method of claim 21, further comprising the step of:
monitoring the electrochemical sensor for at least one condition;
wherein the step of applying the plurality of different bias settings comprises selectively switching between the different bias settings based on the at least one condition.

26. The method of claim 25, wherein the step of monitoring the electrochemical sensor comprises monitoring at least one of oxygen concentration, signal noise, signal sensitivity, and baseline shifts.
